(19) United States
(12) Patent Application Publication
(10) Pub. No.: US 2026/0340296 A1
(43) Pub. Date: Oct. 29, 2026

(54) TASK-ORIENTED ENGAGED CONVERSATION FOR DIGITAL HUMAN

(71) Applicant: I-verse Human Avatar Ltd., Petah-Tikva (IL)

(72) Inventors: Obed Zvi MAIMON, Nir Tzvi (IL); Zohar MAIMON, Shoval (IL); Shira SPETTER, Givat Shmuel (IL); Yeari VIGDER, Tel Aviv-Yafo (IL)

(21) Appl. No.: 19/124,323

(22) PCT Filed: Oct. 17, 2023
(86) PCT No.: PCT/IL2023/051082

§ 371 Date: Apr. 25, 2025

Related U.S. Application Data
(60) Provisional application No. 63/419,354, filed on Oct. 26, 2022.

(51) Int. Cl. G06F 40/35; G06F 40/40; G06Q 10/0639; G06Q 30/0601; G06T 13/40; G06T 13/80

(52) U.S. Cl. CPC G06F 40/35; G06F 40/40; G06Q 10/06393; G06Q 30/0613; G06T 13/40; G06T 13/80

(57) ABSTRACT

A method of conducting a task-oriented, engaged conversation between a computer and a human subject includes: defining a task and one or more key performance indicators for the task; determining an outline of a conversation with the subject in accordance with the task and one or more key performance indicators; performing a dialogue with the subject in a series of acts, wherein each act comprises: (i) determining a strategic goal for the act; (ii) formulating a statement to present to the subject and a manner of presenting the statement to the subject, in accordance with the goal, (iii) presenting the statement to the subject; (iv) receiving a response from the subject, (v) analyzing the response based on both the text and visual cues generated by the subject; and (vi) determining a strategic goal for a subsequent act in accordance with the response and a cumulative state of the conversation.

### RELATED APPLICATIONS

This Application claims the benefit of priority to U.S. Provisional Patent Application No. 63/419,354, filed Oct. 26, 2022, entitled “Task-Oriented Engaged Conversations Between Computers and Human Subjects,” the contents of which are hereby incorporated by reference as if fully set forth herein.

### FIELD OF THE INVENTION

The present disclosure, in some embodiments, concerns conversations between computers and human subjects, and more specifically, but not exclusively, to systems and methods for planning, conducting, and analyzing a conversation between the computer and the human subject.

### BACKGROUND OF THE INVENTION

Companies currently conduct certain business conversations using digital humans. Digital humans are computer programs that communicate autonomously with people, through media such as text, audio, and video. Digital humans may be deployed as avatars or “chatbots.” Digital humans may be utilized to communicate with people on a variety of matters, including but not limited to sales, employment interviews, customer support, and IT support.

In recent years, the percentage of such conversations that are entrusted to digital humans has steadily increased. One advantage of digital humans over human agents is that digital humans are always available and have unlimited time. Another advantage is that digital humans are capable of learning and inferring better than human agents. In addition, a digital human, once trained, may be less expensive to maintain than an employee.

However, various challenges limit the utility of digital humans. People perceive digital humans as lacking understanding of human emotion and lacking human problem-solving intelligence. One particular challenge for digital humans is adjusting to the flow of a conversation. Many digital humans are programmed to ask a closed set of questions. For example, the digital human may run through an entire checklist of questions, regardless of how the subject responded to the prior questions. In other examples, the subject has a limited number of acceptable responses (e.g., yes or no, or selection from a menu), and the digital human provides the next question based on the selected response. However, if the digital human poses non-sequitur questions, or asks questions that do not naturally flow from the prior responses, the person engaging the digital human may quickly lose interest.

### SUMMARY OF THE INVENTION

The present disclosure provides a system and method for conducting a task-oriented, engaged conversation between a digital human and a human subject. The term “task-oriented” signifies that each sentence spoken by the digital human is selected with a particular objective in mind. The term “engaged conversation” signifies that the digital human adapts the flow of the conversation to the responses of the subject in real time.

The task-oriented engaged conversation may be adapted to any type of business objective, including, for example, development of sales leads, closing of sales, interviewing of candidates, performing IT consultations, responding to customer service requests, performing financial consultations, or providing personalized training.

In order to enable tailoring of the conversation to the circumstances of the conversation, the digital human conducts the conversation in a series of “acts.” Each “act” consists of a new, unscripted statement determined in real time based on the state of the conversation to that point in view of the overall objective of the conversation. When determining the next statement to deliver, the digital human considers not only verbal responses by the subject but also nonverbal cues and any information about the subject learned during the conversation.

According to a first aspect, a method of conducting a task-oriented, engaged conversation between a computer and a human subject is disclosed. The method includes: defining a task and one or more key performance indicators for the task; determining an outline of a conversation with the subject in accordance with the task and one or more key performance indicators; performing a dialogue with the subject in a series of acts, wherein each act comprises: (i) determining a strategic goal for the act; (ii) formulating a statement to present to the subject and a manner of presenting the statement to the subject, in accordance with the goal, (iii) presenting the statement to the subject; (iv) receiving a response from the subject, (v) analyzing the response based on both the text and visual cues generated by the subject; and (vi) determining a strategic goal for a subsequent act in accordance with the response and a cumulative state of the conversation.

In another implementation according to the first aspect, the method further includes performing the step of defining a task and one or more key performance indicators autonomously with the computer based on predetermined constraints.

In another implementation according to the first aspect, the method further includes performing the step of defining a task and one or more key performance indicators by a human manager of the computer.

In another implementation according to the first aspect, for at least one act in the series of acts, the steps of presenting and receiving the response comprise animating a digital human with at least one of a set of communication modes comprising audio, video, and text.

Optionally, the method further includes generating an appearance and speech mannerisms of the digital human in accordance with an expected preference of the human subject.

Optionally, the method further includes selecting a personality type for the digital human in accordance with an expected preference of the human subject.

Optionally, the method further includes evaluating whether one or more key performance indicators may be better achieved with a person instead of the digital human, and, if the evaluating step results in a determination that the key performance indicators would be better achieved with the person, transitioning the conversation from the digital human to the person.

Optionally, the method further includes transitioning a delivery of the response during the conversation between different communication modes.

In another implementation according to the first aspect, the method further includes training the computer with a large-language model and logic regarding conducting of conversations derived from stored data.

Optionally, the training step further comprises performing a fine-tuning of the large language model based on the logic.

Optionally, the stored data comprises one or more of: (1) previously recorded conversations involving the computer; (2) previously recorded conversations from other media; and (3) industry research.

In another implementation according to the first aspect, the method further includes commencing each act within approximately 200 milliseconds of completion of a previous act.

In another implementation according to the first aspect, the step of analyzing the response comprises analyzing the text and visual cues as they are received in real time.

In another implementation according to the first aspect, the method further includes performing a post-conversation analysis, and using results of the post-conversation analysis to improve subsequent performance of the computer.

Optionally, the post-conversation analysis includes analysis regarding optimization of the outline, optimization of each statement that was presented, and achievement of the one or more key performance indicators.

In another implementation according to the first aspect, the task is interviewing the subject for an employment position.

Optionally, the one or more key performance indicators comprise determining vectors corresponding to a plurality of personality traits.

Optionally, the method further includes comparing the determined vectors to predefined vectors representing ideal personality traits for the employment position.

Optionally, the comparing step comprises plotting the vectors on a polygon and comparing a shape of the polygon of the determined vectors to a shape of the polygon of the predefined vectors.

In another implementation according to the first aspect, the task is selling a service or product to the subject.

Optionally, the one or more key performance indicators comprise one or more of: classifying a lead, developing a lead, closing a sale, conducting a follow-up conversation after a sale, or conducting a full sales conversation.

According to a second aspect, a computer program product for conducting a task-oriented, engaged conversation between a computer and a human subject includes: a cognitor module for: defining a task and one or more key performance indicators for the task; determining an outline of a conversation with the subject in accordance with the key performance indicator; and, during performance of a dialogue with the subject in a series of acts, analyzing responses by the subject based on both text and visual cues generated by the subject, and determining a strategic goal for each act in accordance with responses received from the subject and a cumulative state of the conversation; and a communicator module for: formulating a statement to present to the subject and a manner of presenting the statement to the subject, in accordance with the goal, presenting the statement to the subject, and receiving a response from the subject.

In another implementation according to the second aspect, the communicator is configured to present the statement by animating a digital human with at least one of audio, video, and text.

Optionally, the communicator is configured to generate an appearance and speech mannerisms of the digital human in accordance with an expected preference of the human subject.

### BRIEF DESCRIPTION OF THE DRAWINGS

FIG. 1 illustrates steps in a method for training a computer system to perform a task-oriented engaged conversation, performing the conversation, and conducting post-conversation analysis, according to embodiments of the present disclosure;

FIG. 2 illustrates a more detailed view of the method steps of FIG. 1, according to embodiments of the present disclosure;

FIG. 3 illustrates a graphical user interface depicting a conversation between a digital human and a human subject, according to embodiments of the present disclosure;

FIG. 4 illustrates output generated by the system when used to analyze suitability of a candidate for an employment position, according to embodiments of the present disclosure; and

FIG. 5 illustrates the planning of different sales conversations, according to embodiments of the present disclosure.

### DETAILED DESCRIPTION OF THE INVENTION

The present disclosure, in some embodiments, concerns conversations between computers and human subjects, and more specifically, but not exclusively, to systems and methods for planning, conducting, and analyzing a conversation between the computer and the subject.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

The systems and methods described herein are implemented by a computer. The computer may include a processor and a memory. The memory may have a computer program stored thereon containing software instructions that, when executed by the processor, cause the processor to perform various functions, as set forth herein. The processor and memory may be stored on a physical computer, on a cloud-based or virtualized computer, or on any combination thereof.

The computer may include various hardware components that enable performance of the conversational functions described herein. These hardware components may include an image sensor, a display, a microphone, and a speaker. In certain implementations, the computer engages in a conversation with a human subject through a multichannel combination of audio, video, and text outputs. These outputs may be communicated through a device (e.g., a computer or mobile telephone) of the human subject. The conversation proceeds, from the perspective of the human subject, similar to a video chat between two people. In such embodiments, the computer need not utilize the integrated hardware components for conducting of the conversation. Regardless, such hardware may be useful for involving a manager in the conversation. The manager may use the display, microphone, camera, and speaker in order to participate in the conversation between the digital human and the subject, as will be discussed further herein.

In the below detailed description, the computer is described as conducting a conversation in the realms of employment interviewing or sales. These uses are merely exemplary, and the computer is equally capable of conducting the conversation in any task-oriented application, including but not limited to education, consulting, IT troubleshooting, or customer service. The conversation may be “business to business” (B2B) or “business to client” (B2C).

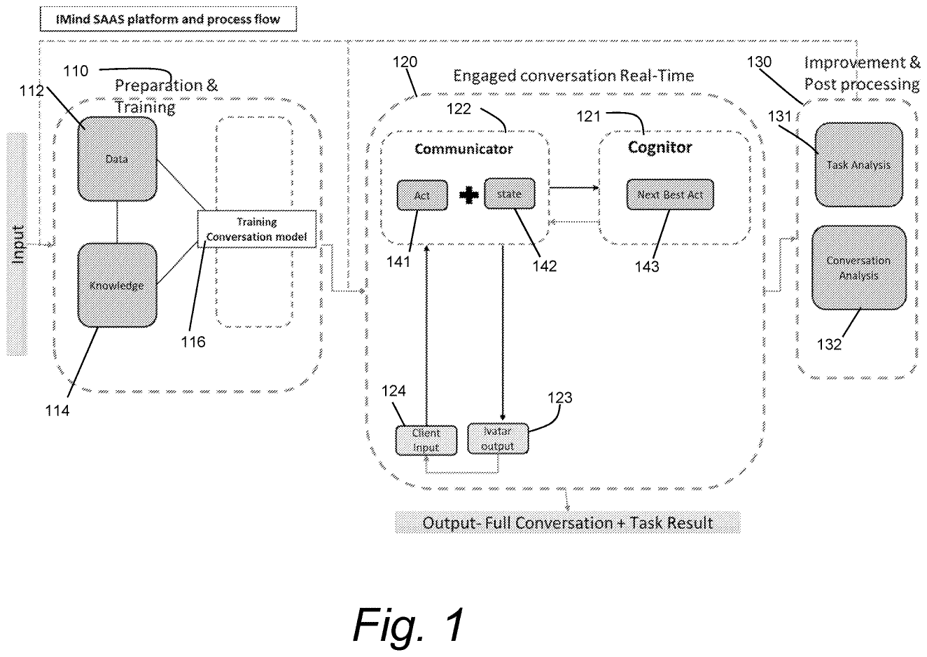

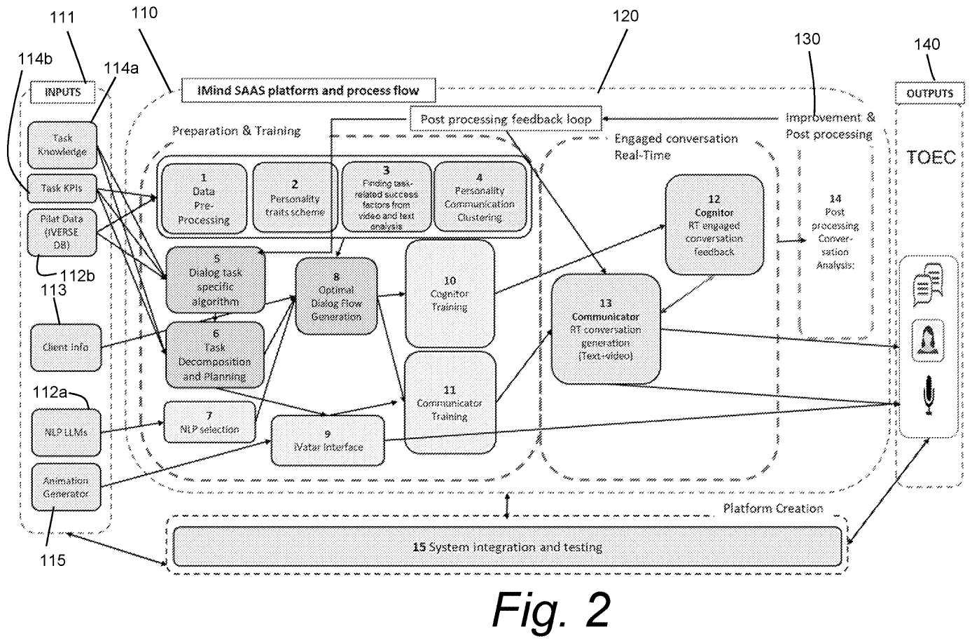

FIG. 1 schematically depicts stages in the training and operation of a computer system for a task-oriented engaged conversation, according to embodiments of the present disclosure. FIG. 2 depicts a more detailed view of the same stages. The operation of the computer system is divided into three stages: a training stage 110, a real-time conversation stage 120, and a post-processing stage 130. The output of the computer system is a task-oriented, engaged conversation 140.

Referring first to training stage 110, the computer system is trained by combining two primary types of inputs 111: data 112 and knowledge 114.

Data 112 refers to examples of spoken text taken from a large language model (LLM) 112a. The large language model 112a may include an extremely large amount of textual parameters that exemplify the syntactical use of language. The data 112 may also derive from previously recorded conversations 112b, whether conversations recorded by the computer system itself or from independently sourced recordings. For example, a database of recorded interviews, consisting of hundreds of thousands of interviews, may be uploaded into a neural network. Each interview may be annotated with one or more tags regarding, for example, the purpose of the interview, the objectives of the interview, how well the candidate performed during the interview, or how statements of the candidate were correlated with skills or personality traits. Optionally, the data obtained from prior conversations may be processed in order to enable more efficient analysis. This processing may include: transcription; correction of syntax, and translation.

Knowledge 114 refers to a logic regarding performance of the types of conversations described herein. The logic may relate to the flow of conversations, including best practices or expected patterns in the performance of these conversations. By way of analogy, a Large Language Model that is trained to generate prose may have difficulty generating a response when the text is a math problem presented in prose format, and the expected response is an answer to the math problem. The LLM needs to be specifically trained to recognize the math problem and generate a suitable response. Similarly, a typical Large-Language Model is not specifically trained for performance of conversations in general, and business conversations in particular, and requires training regarding the typical flow and structuring of such conversations. The knowledge 114 may also relate to recognition of certain conclusions from patterns in speech. For example, a user that repeats the same answer multiple times may be deemed evasive or non-responsive.

Knowledge 114 also relates to global industry information 114a regarding tasks, including key performance indicators (KPIs) 114b for different types of tasks or conversations. In the context of interviews, knowledge 114 may include desirable traits for certain positions. For example, an executive may require the ability to delegate and manage, whereas an executive assistant may require the ability to multitask. This knowledge may be derived from published literature and hundreds of thousands of data points regarding (for example) sales, personality traits, and leadership qualities. In the context of sales, the KPIs may include quantity or price points of sales.

The data 112 and knowledge 114 are combined into a conversation model 116. The conversation model 116 incorporates artificial intelligence (AI) and natural language processing (NLP) and is used to generate human-like sentences, specifically for dialogue.

Preferably, the conversation model 116 is a fine-tuned version of an auto-regressive model such as Generative Pre-Trained Transformer 3 (GPT-3). Fine-tuning refers to a process of modifying or tweaking particular layers of a neural network in order to adapt a model that has already been trained for one given task to make it perform a second similar task. The fine-tuning process is also known as transfer learning. In the present context, the fine-tuning is performed in order to adjust a model initially designed for generation of continuous coherent text (which is the primary application of large language models such as GPT-3) and applying this learning toward the generation of intelligent dialogue, as discussed.

As shown in FIG. 2, other inputs 111 may be provided prior to the commencement of the conversation. Specifically, client information 113 may include information about an interview subject (e.g. age, gender, experience). Animation generator 115 is a computer program or module that is used to generate and animate a digital human.

As seen in FIG. 2, the training 110 may proceed in multiple sub-stages 1-11. The sub-stages address processing of the inputs in order to derive therefrom the planning and presentation of a task-oriented engaged conversation, as discussed above and below.

Referring now to the real-time conversation stage 120, the computer performs a conversation according to the following sequence of steps.

First, prior to commencing the conversation, the computer system defines a task and one or more key performance indicators (KPIs) for the task. The task may be, for example, conducting a sale, and the key performance indicators may include selling a certain number of units or services at a given price. The task may alternatively be conducting an interview, and the key performance indicators may be determining scores for the interviewee regarding certain personality traits.

Optionally, the computer system itself determines the nature of the task and key performance indicators. The system may determine the task and KPIs based on constraints that are preprogrammed into the system. For example, the system may be programmed to sell at a target price point, and may be authorized to give discounts up to 25%. The human subject may also state the reason for initiating contact, which, in turn, helps the computer system define the task and KPIs. Alternatively, a manager of the computer system may set a task and KPIs prior to each interview.

The system then determines an outline of the conversation with the subject in accordance with the task and key performance indicators. The outline dictates, in general terms, the expected structure of the conversation, including milestones which the conversation is expected to pass. For example the conversation may include an “introduction” phase, in which the computer system and the human subject introduce themselves and make small talk; a “body” phase, which is directed to the task at hand, and a “wrap-up” phase, in which the computer summarizes the conversation and identifies follow-up actions. When the conversation includes multiple distinct KPIs (for example, testing of multiple personality traits), the system may further identify a particular order in which it will attempt to achieve the relevant KPIs.

Next, the system performs a dialogue with the human subject of the conversation. The dialogue proceeds in a series of acts. As used in the present disclosure, the term “act” refers to a round of dialogue between the computer and the subject.

Each act includes the following sub-steps: determining a strategic goal for the act, formulating a statement to present to the subject and a manner of presenting the statement to the subject, in accordance with the goal, presenting the statement to the subject and receiving a response from the subject; and determining a strategic goal for a subsequent act in accordance with the response and a cumulative state of the conversation.

For example, the strategic goal may be to evaluate the candidate's adaptability. The specific question that is formulated and delivered to the subject may be a question to the candidate regarding how he or she would respond to a particular scenario. Following receipt of the response, the computer system evaluates what the strategic goal for the next question should be.

This flow of the conversation may be executed by two separate software modules, which are referred to herein as “cognitor” 121 and “communicator “122.” The cognitor 121 performs the strategic planning, both prior to the conversation (setting a task and KPIs, formulating an outline) and during the conversation (determining the objective of each subsequent act). The communicator 122 executes the strategic plan by formulating the specific wording of each statement, as well as by determining the appearance of the digital human and the tone of the digital human during the delivery of the statement. The communicator 122 also determines the physical gestures of the digital human and adapts the gestures to match the text that is being delivered (for example, delivering an ironic statement with a wink).

Control of the conversation proceeds cyclically between the cognitor 121 and communicator 122. Following identification of a strategic goal, communicator 122 delivers output 123, e.g., a statement, to the subject. Optionally, this output is delivered via a digital human having the form of an avatar, referred to herein as an “Ivatar.” The subject then responds to the statement, providing client input 124. The process then proceeds with intent recognition.

Intent recognition is performed through recognition of the text spoken by the human subject in combination with cues such as facial appearance, speaking tone, and speed of speech. The text spoken by the human subject is analyzed using standard natural language processing techniques that are known to those of skill in the art. All textual information is considered, even if not directly responsive to the previous statement by the computer. Such information may be of relevance for an overall understanding of the subject, which may in turn affect the strategy for how to proceed with the conversation. For example, the subject may indicate parenthetically that he has a daughter, or drives a pickup truck, or runs marathons. Each of these points may cause the cognitor 121 to reevaluate the conversation and redirect the conversation to a different angle than that which was previously planned.

With regard to nonverbal cues, the video and audio of the human subject are analyzed using machine learning techniques for detecting voice inflection and volume, and for detecting hand and facial motions. Optionally, the intent recognition module evaluates statements of subjects through analysis of the subject's “Regular Expressions” (Regex). As used in the present disclosure, the term “regular expressions” refers to repeating patterns of syntax of a speaker. One example of a Regular Expression would be to use a certain word W with a frequency of every X sentences or every time period T. Regular Expressions may be used to evaluate speaking patterns on the following planes: textual (e.g., using language such as “we” as opposed to “I”); audio (speed and tone of speech); visual (use of facial expressions that are appropriate for the conversation) and video (appropriate body language and hand gestures).

Following the intent recognition, the cognitor 121 evaluates the state 142 of the conversation as a whole, in view of the most recently completed act 141, and in view of the overall goals of the conversation. The “state” 142 may be analogized to a state of a chessboard following a given move, and the last act 141 may be analogized to the last move. The strategic analysis of the next goal to attain is influenced by both the overall state and the last act, or the most recent acts. For example, if a subject has evaded answering a question, the system may formulate a different strategy for proceeding compared to a subject that has consistently answered forthrightly.

This analysis of the next goal to achieve considers both the expected achievement of the task and the engagement of the subject (the flow of the dialogue). For example, if the cognitor 121 initially has a goal to complete a sale, but the human subject states during the conversation that he requires his partner's approval before completing the sale, the cognitor will no longer attempt to complete the sale, but instead invite the human subject to bring his partner, or to schedule a new time to continue the conversation.

The analysis of intent recognition and the subsequent determination of the next act occur in real time. As a result, the communicator delivers the next statement within a typical time of completion of the last sentence by the subject (e.g., up to around 200 milliseconds). The human subject does not perceive any lag in the pace of the conversation.

This loop of acts proceeds until the cognitor 121 determines that there is no need to continue the conversation. This may be because all the KPIs have been achieved or because, in view of the responses, it is not possible to advance the KPIs any further. The cognitor 121 then instructs the communicator 122 to deliver a statement ending the conversation.

As discussed above, prior to commencement of the conversation, the communicator 122 may determine a desired persona for the virtual human. The persona includes an appearance for the virtual human and a language and accent in which the digital human is to communicate. The communicator 122 may generate a visual appearance and mannerisms that are adapted to the style of each customer or interviewee. The communicator 122 may also select a personality type for the digital human in accordance with an expected preference of the human subject. In order to enable this assessment, prior to commencement of the conversation (or during the initial stages of the conversation), the system may engage the human subject in a series of questions designed to identify the demographic characteristics and personality type of the human subject. For example, the personality type may be classified based on the PAEI model developed by Adizes, the Big 5 personality taxonomy, or the OPQ (Occupation Personality Questionnaire) personality test. In addition, the system may generate a database of stock characters with certain appearances and personas with different personality types as defined above. The appearances and personas may be chosen based on research and data regarding which personality types are best suited to conduct conversations with particular goals, as well as which personality types are best-suited to conduct conversations with other personality types.

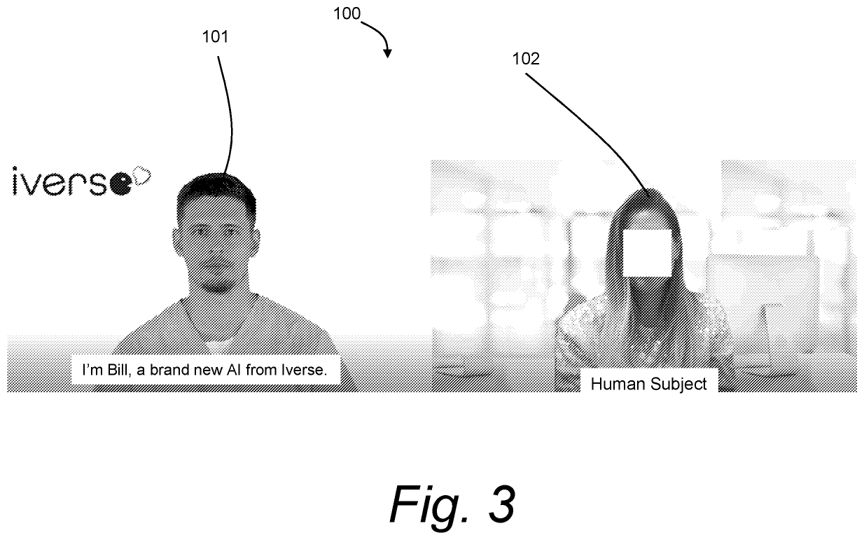

FIG. 3 illustrates an example of a screenshot 100 of a conversation between a digital human 101 and a human subject 102. The digital human 101 appears on one side of the split screen and the human subject 102 appears on the other side of the split screen. In the captured screen shot 100, the digital human 101 is introducing itself to the human subject. The digital human may communicate with the subject using a combination of audio, video, and text. The video may include physical gestures performed by the digital human, such as opening of mouth, opening of eyes, and movement of eyebrows, as illustrated. The video presentation may include a transcript of the statement being spoken by the digital human, as illustrated.

Optionally, the system is built in an “omnichannel” manner that enables seamless transition between different modes of communication. Thus, a conversation may start with a video dialogue between a human subject and a digital human but may continue as a text-based or email-based discussion between the human subject and the computer system.

Optionally, the computer system may also evaluate whether one or more key performance indicators may be better achieved with a manager instead of the digital human. This evaluation may proceed, for example, on a basis of the pace of progress of the conversation, or in response to a specific request by the human subject. If the computer system determines that the key performance indicators would be better achieved with the manager, the computer may transition the conversation from the digital human to the manager. In the example of a sale, the human subject may display dissatisfaction with the progress of the conversation with the digital human and request a human representative. In the context of interviews, the system may reach inconclusive or contradictory results regarding the suitability of a candidate for a position, and thus may choose to refer the candidate to a manager for further evaluation. A conversation that includes a transfer between the system and a human agent is referred to herein as a “hybrid” conversation.

At post-processing stage 130, the computer system engages in up to two types of analysis: task analysis 131 and conversation analysis 132. These analyses may be automated and/or may be performed under supervision of a manager. In task analysis 131, the computer evaluates whether it achieved its desired tasks and KPIs. The computer further evaluates whether it structured the conversation in the most effective manner in order to achieve the desired task and KPIs. For example, if a particular statement by the computer generated a negative reaction by the human subject, the computer may take note of this and incorporate this negative outcome into the data sets. In this way, the logic model employed by the cognitor 121 continually improves. In conversation analysis 132, the computer evaluates the flow of the conversation itself. This evaluation may include statistical analysis of the length of the conversation, the types of questions asked, and the order of questions asked. This analysis may also include comparison of a given conversation to other conversations generated at similar times or having similar KPIs.

As discussed above, the system described herein may be implemented for various types of task-oriented conversations. In the examples described herein, the system is used for two specific types of conversations: employment interviews and sales conversations.

With respect to employment interviews, the system may be used to screen candidates and to determine suitability for a particular role. During employment interviews, the specific KPIs for the conversation may include determining vectors corresponding to a plurality of personality traits. These personality traits may be selected based on proprietary, research-based data regarding which traits are best-suited to particular positions.

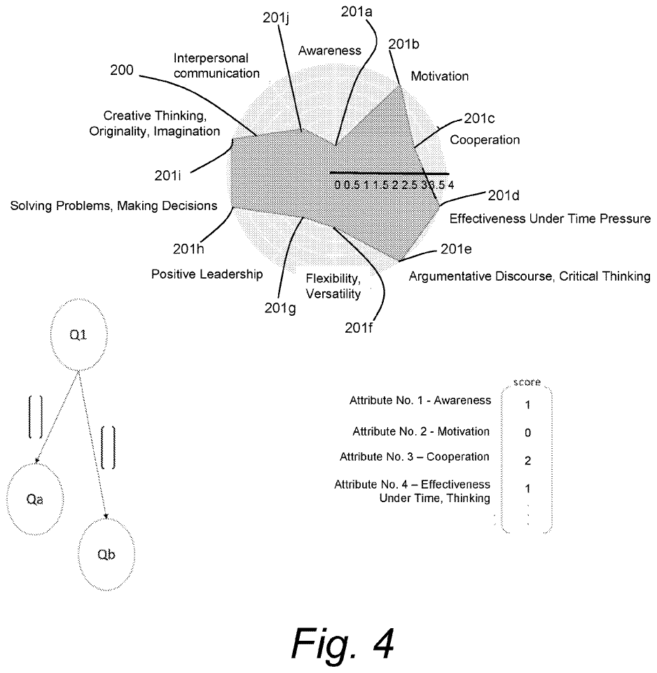

FIG. 4 illustrates a form of post-processing output that may be generated by the system when used specifically for employment interviews. In the illustrated example, the human subject is given scores for the character traits of awareness 201a, motivation 201b, cooperation 201c, effectiveness under time pressure 201d, argumentative discourse and critical thinking 201e, flexibility and versatility 201f, positive leadership 201g, solving problems and making decisions 201h, creative thinking originality and imagination 201i, and interpersonal communication 201 j. Each of these traits is graded on a scale of 0 to 4. The traits are then mapped on a circular plot having a radius of 4, with a ten-sided polygon inscribed at ten points along the circumference of the circle, in which each vertex represents one of the measured personality traits. The post-processing module may then compare the polygon generated for each interviewee with an ideal polygon representing the preferred personality traits of the desired employee, in order to determine which candidate is the best fit for the job.

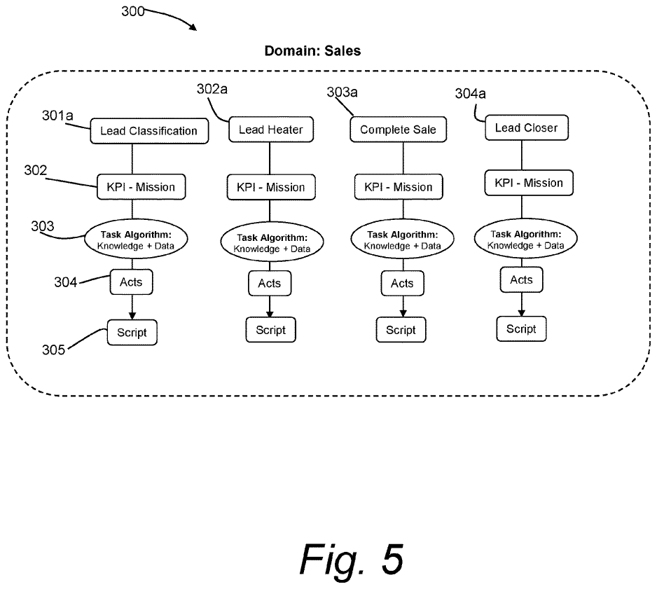

FIG. 5 illustrates different steps for deploying the system for use in sales, according to embodiments of the present disclosure. Within sales, there can be different types of conversations. A “lead classifier” conversation 301a identifies leads, and determines which leads are most relevant and most promising. This information may be sent to sales agents for additional work. A “lead heater” conversation 301b takes place with a client that has already expressed initial interest. This conversation supplies information to a customer about a product and may further include referring the customer to a sales agent. A “complete sale” conversation 301c may encompass the entire sales process from initial intake to completing the sale, and a “lead closing” conversation 301d may focus just on completing a sale. A specific example of a “lead closing” conversation may be a “full cart” conversation, in which the system responds to abandonment of a shopping cart in an e-commerce website and opens a conversation in order to encourage the customer to complete the sale. Another type of sales conversation may be a follow-up conversation after a sale.

FIG. 5 further illustrates a pipeline for developing the sales conversation, which may be the same regardless of the specific task. For each type of sales conversation, a key performance indicator (KPI) 302 is identified. For example, the KPI may be to sell a certain number of units to the buyer at a certain price. At step 303, an algorithm is applied, based on the knowledge and data resources, as discussed, to generate an outline of the “acts” 304. The outline includes different milestones for the conversation, as discussed above. The conversation then proceeds by development of a script 305 for each act 304, as discussed above.

What is claimed is:

1. A method of conducting a task-oriented, engaged conversation between a computer and a human subject, comprising:
defining a task and one or more key performance indicators for the task;
determining an outline of a conversation with the subject in accordance with the task and one or more key performance indicators;
performing a dialogue with the subject in a series of acts, wherein each act comprises: (i) determining a strategic goal for the act; (ii) formulating a statement to present to the subject and a manner of presenting the statement to the subject, in accordance with the goal, (iii) presenting the statement to the subject; (iv) receiving a response from the subject, (v) analyzing the response based on both the text and visual cues generated by the subject; and (vi) determining a strategic goal for a subsequent act in accordance with the response and a cumulative state of the conversation.

2. The method of claim 1, further comprising performing the step of defining a task and one or more key performance indicators autonomously with the computer based on predetermined constraints.

3. The method of claim 1, further comprising performing the step of defining a task and one or more key performance indicators by a human manager of the computer.

4. The method of claim 1, wherein, for at least one act in the series of acts, the steps of presenting and receiving the response comprise animating a digital human with at least one of a set of communication modes comprising audio, video, and text.

5. The method of claim 4, further comprising generating an appearance and speech mannerisms of the digital human in accordance with an expected preference of the human subject.

6. The method of claim 4, further comprising selecting a personality type for the digital human in accordance with an expected preference of the human subject.

7. The method of claim 4, further comprising evaluating whether one or more key performance indicators may be better achieved with a person instead of the digital human, and, if the evaluating step results in a determination that said key performance indicators would be better achieved with the person, transitioning the conversation from the digital human to the person.

8. The method of claim 4, further comprising transitioning a delivery of the response during the conversation between different communication modes.

9. The method of claim 1, further comprising training the computer with a large-language model and logic regarding conducting of conversations derived from stored data.

10. The method of claim 9, wherein the training step further comprises performing a fine-tuning of the large language model based on the logic.

11. The method of claim 9, wherein the stored data comprises one or more of: (1) previously recorded conversations involving the computer; (2) previously recorded conversations from other media; and (3) industry research.

12. The method of claim 1, further comprising commencing each act within approximately 200 milliseconds of completion of a previous act.

13. The method of claim 1, wherein the step of analyzing the response comprises analyzing the text and visual cues as they are received in real time.

14. The method of claim 1, further comprising performing a post-conversation analysis, and using results of the post-conversation analysis to improve subsequent performance of the computer.

15. The method of claim 14, wherein the post-conversation analysis includes analysis regarding optimization of the outline, optimization of each statement that was presented, and achievement of the one or more key performance indicators.

16. The method of claim 1, wherein the task is interviewing the subject for an employment position.

17. The method of claim 16, wherein the one or more key performance indicators comprise determining vectors corresponding to a plurality of personality traits.

18. The method of claim 17, further comprising comparing the determined vectors to predefined vectors representing ideal personality traits for the employment position.

19. The method of claim 18, wherein the comparing step comprises plotting the vectors on a polygon and comparing a shape of the polygon of the determined vectors to a shape of the polygon of the predefined vectors.

20. The method of claim 1, wherein the task is selling a service or product to the subject.

21. The method of claim 20, wherein the one or more key performance indicators comprise one or more of: classifying a lead, developing a lead, closing a sale, conducting a follow-up conversation after a sale, or conducting a full sales conversation.

22. A computer program product for conducting a task-oriented, engaged conversation between a computer and a human subject, comprising:
a cognitor module for: defining a task and one or more key performance indicators for the task; determining an outline of a conversation with the subject in accordance with the key performance indicator; and, during performance of a dialogue with the subject in a series of acts, analyzing responses by the subject based on both text and visual cues generated by the subject, and determining a strategic goal for each act in accordance with responses received from the subject and a cumulative state of the conversation; and
a communicator module for: formulating a statement to present to the subject and a manner of presenting the statement to the subject, in accordance with the goal, presenting the statement to the subject, and receiving a response from the subject.

23. The computer program product of claim 22, wherein the communicator is configured to present the statement by animating a digital human with at least one of audio, video, and text.

24. The computer program product of claim 23, wherein the communicator is configured to generate an appearance and speech mannerisms of the digital human in accordance with an expected preference of the human subject.
